(19) United States
(12) Patent Application Publication
(10) Pub. No.: US 2012/0117775 A1
(43) Pub. Date: May 17, 2012

(54) Extraction Stabilizer

(75) Inventor: Mark Tomasic, Trafford, PA (US)

(73) Assignee: BOMBARDIER TRANSPORTATION GMBH, Berlin (DE)

(21) Appl. No.: 12/945,159

(22) Filed: Nov. 12, 2010

(51) Int. Cl. H01R 43/22; H01R 43/00

(52) U.S. Cl. 29/426.1; 29/764

(57) ABSTRACT

A pin extraction stabilizer for an connector housing is disclosed. The housing includes a top surface and a bottom surface and defines one or more connector pin cavities extending therethrough between the top and the bottom surfaces with a plurality of protruding hollow plugs extended around the connector pin cavities at the top surface. The connector housing further includes one or more connector pins pre-disposed within the connector housing that need to be extracted via the pin extraction stabilizer. The pin extraction stabilizer includes a stabilizer housing having a front surface and a back surface and defines a one or more access sockets extending from the stabilizer front surface to the stabilizer back surface defining a plurality of chambers in the stabilizer. Each chamber of the plurality of chambers is dimensioned to receive a protruding hollow plug of the connector housing.

### BACKGROUND OF THE INVENTION

1. Field of the Invention

The present invention relates to the removal of connector pins from electronic electrical housings, and, more particularly, to a pin extraction stabilizer for the removal of connector pins.

2. Description of Related Art

Connector housings often include housings having one or more connector pin cavities extending therethrough wherein a plurality of connector pins extend through the apertures to mate to a corresponding female electronic housing. The electronic connection housings often include connector pin plugs positioned about the periphery of each of the apertures and extending to a point above the apertures. The connector pins generally extend through both the apertures and the plugs. Oftentimes during routine maintenance, the connector pins are required to be removed and/or replaced. There are a number of tools, for example, those described in the U.S. Pat. Nos. 3,844,013, and 4,414,736, to facilitate removal of connector pins from a connector housing. However, many times during removal, the connector pin plugs, which are often made of a plastic or polymer material, break and/or shatter; thereby, requiring replacement of the entire connector housing. This results in loss of time and money during manufacture and/or maintenance of electronic equipment. A need exists to provide a means of ensuring that the connector pin plugs of the connector housings are not broken or mishandled during maintenance, thereby, resulting in significant reductions of cost, time, and manpower during manufacture and/or maintenance procedures.

### SUMMARY OF THE INVENTION

A pin extraction stabilizer is disclosed for a connector housing. The connector housing may include a housing having a front surface and a back surface and defining one or more connector pin cavities extending therethrough a plurality of protruding hollow plugs for receiving a plurality of connector pins. The pin extraction stabilizer includes a stabilizer housing having a front surface and a back surface. The stabilizer housing defines one or more access sockets extending from the stabilizer front surface to the stabilizer back surface. Each socket is dimensioned to receive a protruding hollow plug. The stabilizer front surface may mirror the housing front surface in shape and size, but is not always necessary. The access sockets may have varying cross-sectional areas at the front end and the back end of the stabilizer housing, with varying inner diameters. The stabilizer front surface may have a cross-sectional area that is greater than the cross-sectional area of the connector pin cavities defined on the stabilizer back surface, and an inner diameter of each chamber of the plurality of stabilizer chambers may be greater than an outer diameter of each plug of the plurality of connector pin plugs. The stabilizer chambers may take the form of counterbored chambers having an inner counterbore stop surface positioned between the stabilizer front surface and the stabilizer back surface. The inner counterbore stop surface may be positioned at a distance from the stabilizer front surface, such that when the connector pin plugs are received within the stabilizer chambers, the plugs are received substantially completely within the stabilizer chambers. The access sockets defined on the stabilizer front surface may have a cross-sectional area that is greater than the cross-sectional area of the access sockets defined on the stabilizer back surface. When the connector pin plugs are received within the stabilizer chambers, the stabilizer front surface may contact the housing front surface. Each plug of the plurality of connector pin plugs may take the form of a tubular extension extending from the housing connector pin cavities to a point above the housing front surface, and each chamber of the plurality of stabilizer chambers take the form of tubular chambers dimensioned to receive the tubular plugs. Each plug of the plurality of connector pin plugs may be cylindrical and each chamber of the plurality of stabilizer chambers may be cylindrical. An inner diameter of each cylindrical chamber of the plurality of stabilizer chambers may be greater than an outer diameter of each cylindrical plug of the plurality of connector pin plugs.

A method of extracting a pin from an connector housing wherein the connector housing includes a plurality of connector pin plugs extending from a front surface of the housing for receiving a plurality of connector pins includes the steps of: providing a pin extraction stabilizer having a front surface and a back surface; positioning the front surface of a pin extraction stabilizer toward the front surface of the connector housing; encasing each connector pin plug of the plurality of plugs within an aperture of one or more connector pin cavities defined in a front surface of the stabilizer front surface; and extracting a pin of the plurality of connector pins received within the plugs from the back surface of the pin extraction stabilizer.

A pin extraction tool may also be provided. The pin may be extracted via the extraction tool and may be extracted from the back surface of the pin extraction stabilizer through an aperture defined in the stabilizer back surface. When a pin extraction tool is provided, the pin extraction tool may be inserted through the aperture defined in the stabilizer back surface, to extract the pin via the pin extraction tool. Prior to extracting the pin, the pin extraction tool may grasp onto the pin. The method may be repeated to extract a second pin of the plurality of connector pins received within the plugs from the back surface of the pin extraction stabilizer. Encasing each connector pin plug can include substantially completely encasing each plug in an aperture of the plurality apertures defined in the stabilizer front surface.

Another embodiment may include a pin extraction stabilizer for aiding in efficient removal of a connector pin predisposed in a connector housing, wherein the connector housing includes one or more connector pin cavities spanning a top and a bottom end; a protruding hollow plug extending around each of the one or more connector pin cavities at the top end with the connector pin inserted from the bottom end of the connector housing and through one of the one or more connector pin cavities and the corresponding protruding hollow plug to expose a connector pin contact beyond the protruding hollow plug. The pin extraction stabilizer may include a front surface; a back surface opposing the front surface; and a plurality of access sockets each extending between the front and the back surface of the pin extraction stabilizer; wherein, placement of each of the access sockets corresponds to placement of the protruding hollow plugs on the connector housing; and wherein each of the access sockets is adapted to engage the corresponding protruding hollow plug of a plurality of plugs of the connector housing when the pin extraction stabilizer is mated with the top end of the connector housing.

The number of access sockets in the pin extraction stabilizer may equal a number of protruding hollow plugs in the connector housing, for example, the number of access sockets comprises 28 access sockets. Each plug can fit within a corresponding access socket of the pin extraction stabilizer when in operation. The access sockets define a first inner cross-section diameter and a second inner cross-section diameter. The first inner cross-section diameter may be different from the second inner cross-section diameter. The first and/or the second inner cross-section diameter of one of the sockets may be different from the first and/or second inner cross-section diameter of another socket of the plurality of sockets. The pin extraction may be adapted to allow an extraction tool to be inserted into the access socket to push out an existing connector pin from the connector housing. The front surface of the pin extraction stabilizer may contacts the top end of the connector housing during operation. The front surface, the back surface, and the access sockets of the extractions stabilizer may be made of, for example, a plastic material, a phenolic or dially phthalate material, a ceramic material, or a metal, such as aluminum, steel, titanium, magnesium, and derivatives thereof. When the material is a metal, the access sockets may include an insulating liner around the periphery of the access sockets.

Another embodiment may include a method of extracting a connector pin predisposed in a connector housing, the connector housing comprising: a connector pin cavity spanning a top and a bottom end and a protruding hollow plug extending around the connector pin cavity at the top end, and wherein the connector pin is inserted from the bottom end of the connector housing and through at least the connector pin cavity and the protruding hollow plug to expose a connector pin contact beyond the protruding hollow plug. The method includes placing a pin extraction stabilizer on the top end of the connector housing, the pin extraction stabilizer comprising at least an access socket extending between a front and a back surface wherein at least one of the connector pins contact and the protruding hollow plug is housed within the corresponding access socket of the pin extraction stabilizer; positioning a connector pin extraction device in an exposed end of the access socket, wherein the access cavity at least partially houses the connector pin to be extracted; and removing the connector pin from the connector housing by working the connector pin extraction device. The step of removing the connector pin may include pushing the connector pin extraction device towards the connector housing, extracting the connector pin without any damage to the connector housing.

### BRIEF DESCRIPTION OF THE DRAWINGS

A more complete understanding of the pin extraction stabilizer can be obtained by considering the following description in conjunction with the accompanying drawing figures.

FIG. 1 is a perspective view of a connector housing;

FIG. 2 is a top plan view of the connector housing of FIG. 1;

FIG. 3 is a cross-sectional side view of the connector housing of FIG. 1;

FIG. 4 is a side view of the connector housing of FIG. 1 with connector pins;

FIG. 5 is a front plan view of a pin extraction stabilizer;

FIG. 6 is a cross-sectional side view of the pin extraction stabilizer of FIG. 5;

FIG. 7 is a perspective view of the pin extraction stabilizer of FIG. 6 and the connector housing of FIG. 1 prior to engagement;

FIG. 8 is a perspective cross-sectional view of the pin extraction stabilizer of FIG. 6 in engagement with the connector housing of FIG. 1;

FIG. 9 is a side view of the pin extraction stabilizer of FIG. 6 in engagement with the connector housing of FIG. 1;

FIG. 10 is a cross-sectional view of the view of FIG. 9;

FIG. 11 is a cross-sectional view of the pin extraction stabilizer of FIG. 6 engaged with the connector housing of FIG. 1 in use with a pin extraction tool; and

FIG. 12 is a diagrammatical representation of a method of extracting a connector pin predisposed in a connector housing.

### DESCRIPTION OF THE PREFERRED EMBODIMENTS

For purposes of description hereinafter/orientation terms if used shall relate to the referenced embodiments as it is contained in the accompanying drawing figures or otherwise described in the following detailed description. However, it is to be understood that the embodiments described hereinafter may assume many alternative variations and embodiments and that specific embodiments illustrated in the accompanying drawing figures, and described herein, are simply exemplary and should not be considered as limiting.

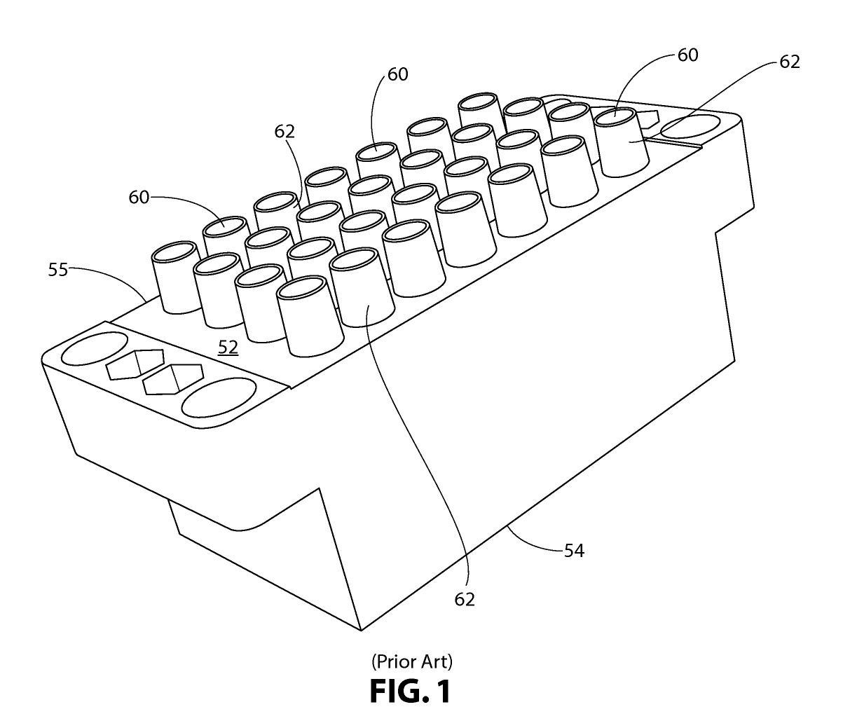

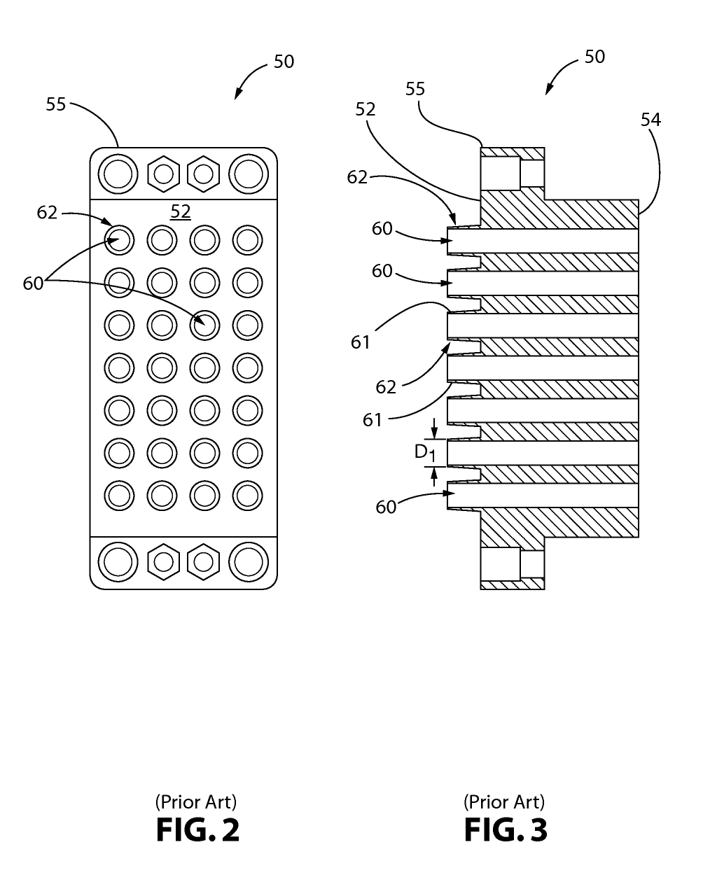

Referring now to FIGS. 1-3, labeled as prior art, a connector housing 50, which is used to house connector pins, includes a connector body 55 having a top end 52 and a bottom end 54. The connector housing 50 defines one or more connector pin cavities 60 extending from the top end 52 to the bottom end 54 of the connector body 55 and having protruding hollow plugs 62. As shown, the protruding hollow plugs 62 extend from the top end 52 of connector housing 50 to some point above top end 52. The length of the protruding hollow plugs 62 are defined based on the design and use of the mating connector housing (not presently shown) that connects with the connector body 55. The protruding hollow plugs 62 simply extend the connector pin cavities from within the housing 50. The plugs 62 may have a constant inner diameter, in one instance, and varying inner diameter in another instance. On the exterior, the plugs 62 may be frusto-conical in shape or cylindrical in shape. FIG. 3 is a cross-sectional side view of the connector housing 50 which clearly shows the connector pin cavities 60 extending from the bottom end 54 to the top end 52 and through the protruding hollow plugs 62. Such connector housings 50 are used in numerous applications, such as for electronic connections in vehicles and machinery such as a communication or signaling equipment.

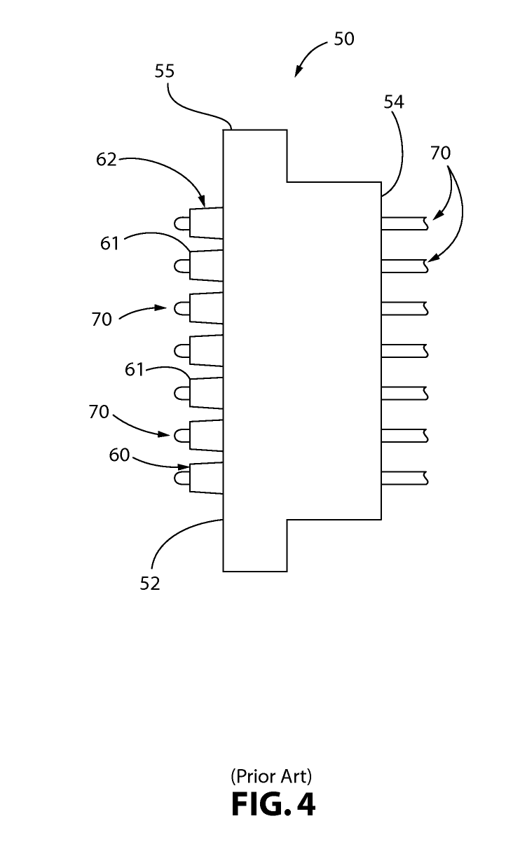

Referring now to FIG. 4, also labeled as prior art, each connector pin cavity 60 generally will include a connector pin 70 extending through the connector pin cavity 60. The connector pin 70 is typically inserted from the bottom end 54, through the connector pin cavity 60 and extending out of the protruding hollow plug 62. As shown, the connector pins 70 may extend beyond an end portion 61 of protruding hollow plugs 62. As explained above, during normal maintenance procedures (such as replacing a faulty connector pin) in which the connector pin 70 must be removed from the connector body 55, the plugs 62 are oftentimes mishandled and are broken during the removal process, particularly during insertion of an extraction tool, discussed in detail below. The protruding hollow plugs 62 are typically made of a phenolic material, as is the connector body 55. However, other materials such as diallyl phthalate may also be used. In general, the choice of the material is made based on the insulating properties of the material desired for the application. A ceramic material may also be considered at times.

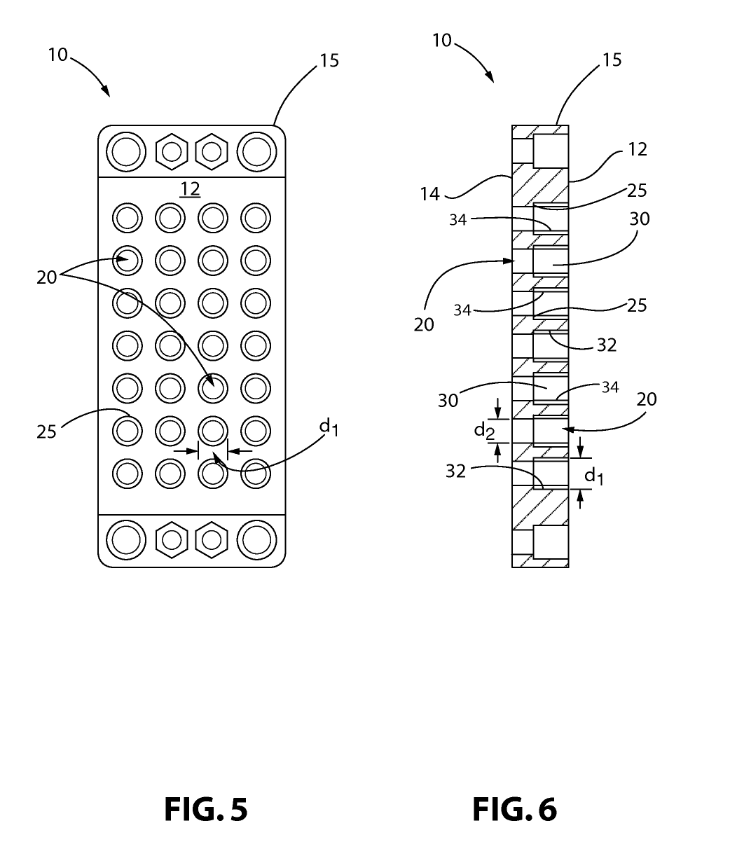

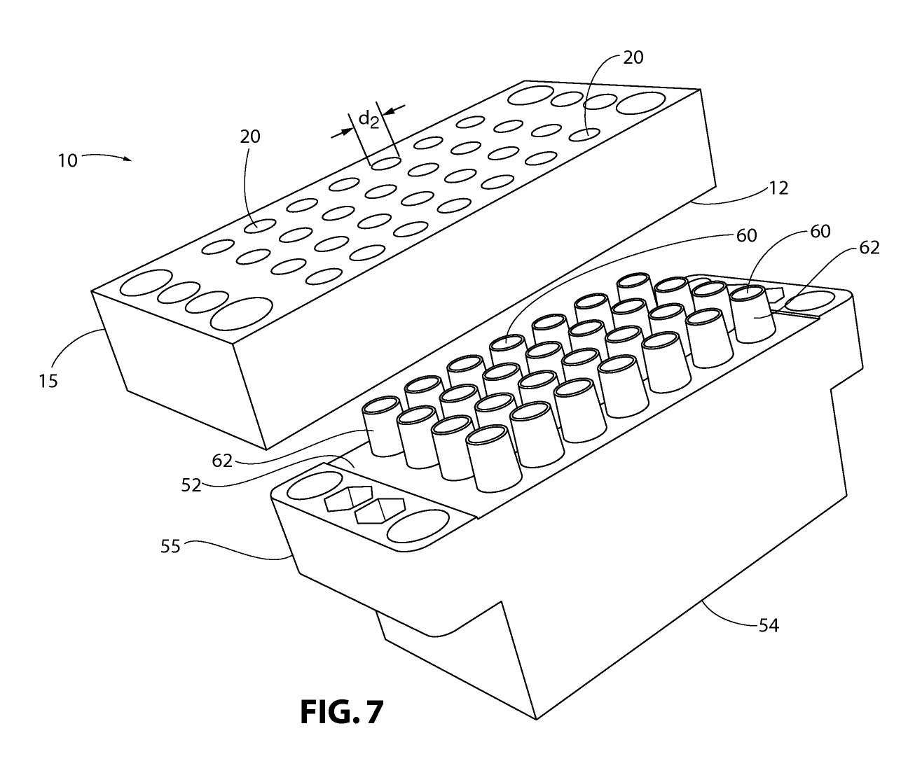

A pin extraction stabilizer 10, shown in FIGS. 5 and 6, prevents breakage, as described above, from occurring. The pin extraction stabilizer 10 includes a stabilizer housing 15 having a front surface 12 and a back surface 14. One or more access sockets 20 are defined through the stabilizer housing 15 extending from front surface 12 to back surface 14. The sockets 20 may take the form of a counterbored aperture, as best shown in FIG. 6, having a counterbored stop surface 25. An inner diameter d1 of the socket 20 on front surface 12 is larger than the inner diameter d2 of socket 20 on the back surface 14 of stabilizer housing 15. Both the pin extraction stabilizer 10 and the connector housing 50 may be constructed of a plastic material, thermoplastic material, ceramic, and/or polymer material, made for example by extrusion or injection molding processes. In other instances, the material for making the pin extraction stabilizer 10 as well as the connector housing 50 may be made of phenolic material or diallyl phthalate material as well. Alternatively, extraction stabilizer 10 may comprise a metal, such as aluminum, steel, titanium, magnesium and/or derivatives thereof. When a metal is used, however, the extraction stabilizer 10 can include insulating layer 34, as shown in FIG. 6, in order to reduce the possibility of short circuiting across electronic connector pin 70 if electronic connector pin 70 inadvertently contacts walls 32 of chamber 30, when pin extraction stabilizer 10 and connector housing 50 are engaged.

The access sockets 20 may have multiple cross-sectional areas. For example, as illustrated in FIG. 6, in one embodiment the cross-section area (having diameter d2) of each access socket 20 at the top end may be smaller than the cross-section area (having diameter d1) of that access socket at the bottom end of the stabilizer housing 15. The two cross-sectional areas of the access socket 20 may be formed via counterboring techniques known in the art. In this instance, the counter-boring creates a stop surface 25 which is the point where the cross-sectional areas change. The depth of the access socket 20 from the bottom surface may vary with each application even though the depth is preferred to be at least the height of the protruding hollow plug of the connector that will be used with the pin extraction stabilizer.

It is also possible for the depth of the access socket 20 between the front surface and the bottom surface to vary from one application to another, and also from one pin extraction stabilizer to another pin extraction stabilizer. The access sockets 20 are dimensioned, such that when the pin extraction stabilizer 10 is placed on top of the connector housing 50, where the front surface 12 of the stabilizer 10 makes contact with the top end 52 of the connector housing 50, each protruding hollow plug 62 is encapsulated by an access socket 20 causing the pin extraction stabilizer 10 to snugly fit on top of the connector housing 50. At least a portion of the access socket 20 is envisioned to have at least the cross-sectional area that will allow the protruding hollow plug 62 to be encapsulated by the access socket 20. Any portion of the access socket 20 that is above the protruding hollow plug 62 (following mating between the pin extraction stabilizer 10 and the connector housing 50) may be of a reduced cross-sectional area, with a limitation that it be sized to allow a pin extraction tool to be inserted through the top surface of the pin extraction stabilizer 10. Each access socket 20 further defines a chamber 30 which is the portion of the access socket 20 between the front surface 12 of stabilizer 10 and the stop surface 25. Every chamber 30 is assumed to be a part of the access socket 20. In other words, when the pin extraction stabilizer 10 is mated with the connector housing 50, each of the protruding hollow plugs 62 is housed within a corresponding chamber 30 of the access socket 20.

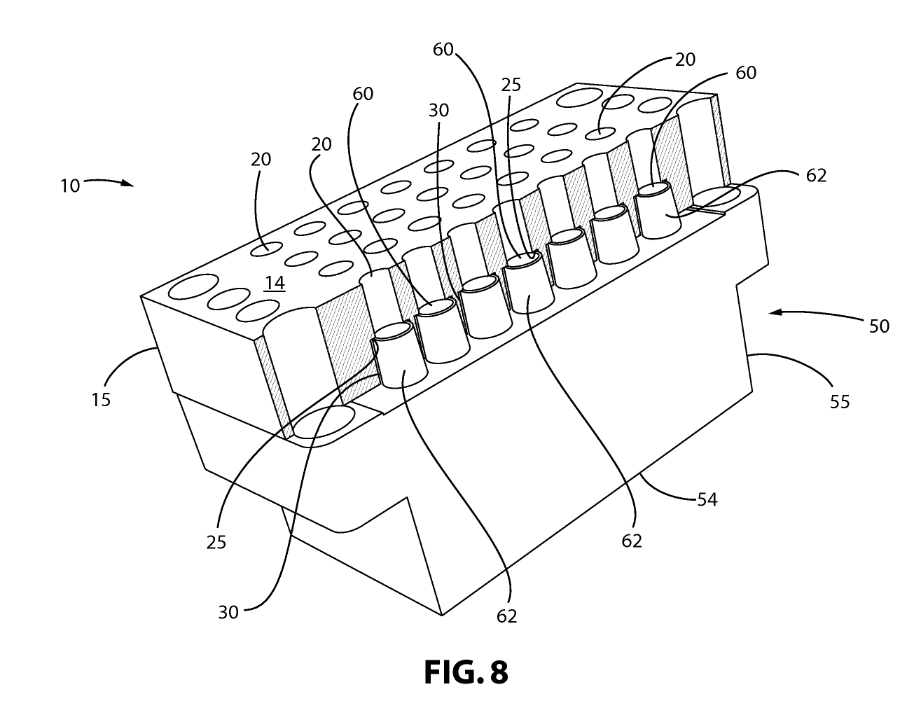

FIG. 7 shows a pin extraction stabilizer 10 and connector housing 50 prior to engagement. As shown, the number of access sockets 20 on the pin extraction stabilizer 10 equals the number of protruding hollow plugs 62 on the connector housing 50. FIG. 7 specifically illustrates a connector housing 50 having twenty-eight protruding hollow plugs 62 with a pin extraction stabilizer 10 having twenty-eight corresponding access sockets 20. In other embodiments, various other connector housings having any different number of protruding hollow plugs may be mated with a pin extraction stabilizer 10 having at least the same number of access sockets. In accordance with another embodiment, it is possible to have a single pin extraction stabilizer that can mate with a connector housing having either a 28-plug configuration or a 36-plug configuration. Such adaptations are considered to be part of the present invention.

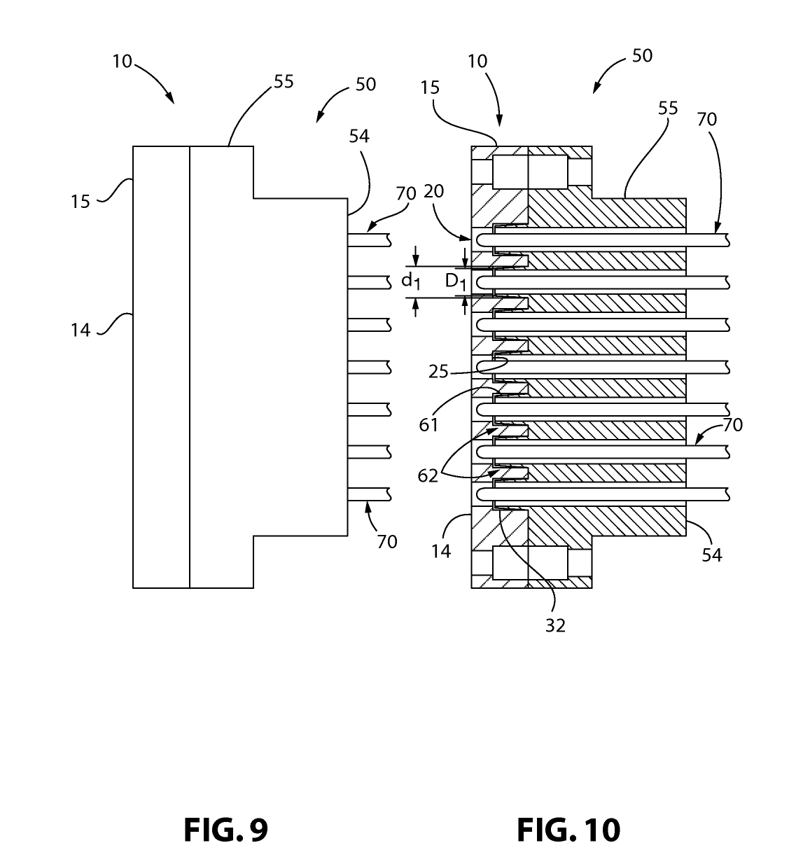

FIGS. 8-10 show a pin extraction stabilizer 10 in engagement with connector housing 50. As discussed above, the existence of the counterbored stop surface 25 in the access socket 20 of the pin extraction stabilizer 10 form the counterbored chamber 30 for receiving each of the protruding hollow plugs 62 of connector housing 50. As illustrated in FIGS. 8-10, when the pin extraction stabilizer 10 is mated with the connector housing 50, the protruding hollow plug 62 will not extend the entire length of chamber 30, regardless of its length. It is, however, preferred that the length of the protruding hollow plug 62 in each connector housing be of substantially the same length. In some instances, one of the plugs 62 may be longer than its corresponding chamber 30. Stop surface 25 in chamber 30 will prevent the plug 62 from extending the entire length through chamber 30 with end portion 61 of plug 62 not being exposed or extending beyond the back surface 14 of pin extraction stabilizer 10. However, it is contemplated that other embodiments of a pin extraction stabilizer 10 may allow plugs 62 of connector housing 50 to extend completely through the access socket 20 beyond back surface 14. It is also noted that the top end 52 of connector housing 50 and front surface 12 of pin extraction stabilizer 10 may contact and abut each other in such a way that plug 62 does not extend entirely into chamber 30 of pin extraction stabilizer 10. The plugs 62 of connector housing 50 may be received partially or substantially completely within the chambers 30 of pin extraction stabilizer 10. What is meant by substantially completely is that most or all of plug 62 will be received in chamber 30, with none or part of plug 62 being exposed at the interface of front surface 12 of pin extraction stabilizer 10 and top end 52 of connector housing 50 due to some variation contemplated between front surface 12 of stabilizer 10 and top end 52 of connector housing 50 resulting in an interface that is not entirely flush at all points.

As noted above, the access sockets 20 and, therefore, the chambers 30, of pin extraction stabilizer 10 are configured and dimensioned to receive plugs 62 of connector housing 50. As shown in the figures, the plugs 62 may take the form of a tubular plug positioned about the periphery of the cavities 60 of connector housing 50, with the electronic connector pin 70 extending therethrough. Therefore, chambers 30 of pin extraction stabilizer 10 would also take the form of a tubular and/or cylindrical chamber so as to be dimensioned to receive a tubular plug 62 of connector housing 50. Because chamber 30 is dimensioned such that it corresponds to the shape of plug 62 of connector housing 50, the inner walls 32 of chamber 30 supply support to the plugs 62 when pin extraction stabilizer 10 is engaged with connector housing 50. It is contemplated that chamber 30 may be any shape that adequately supports plug 62 of connector housing 50, such as, a frusto-conical shape. As best shown in FIG. 10, little or no space exists between plugs 62 and walls 32 of chamber 30 when the pin extraction stabilizer 10 is engaged with connector housing 50. This lack of space minimizes any lateral movement when a pin extraction tool, described below, is inserted into plug 62 to remove a damaged pin from connector housing 50 during routine maintenance procedures.

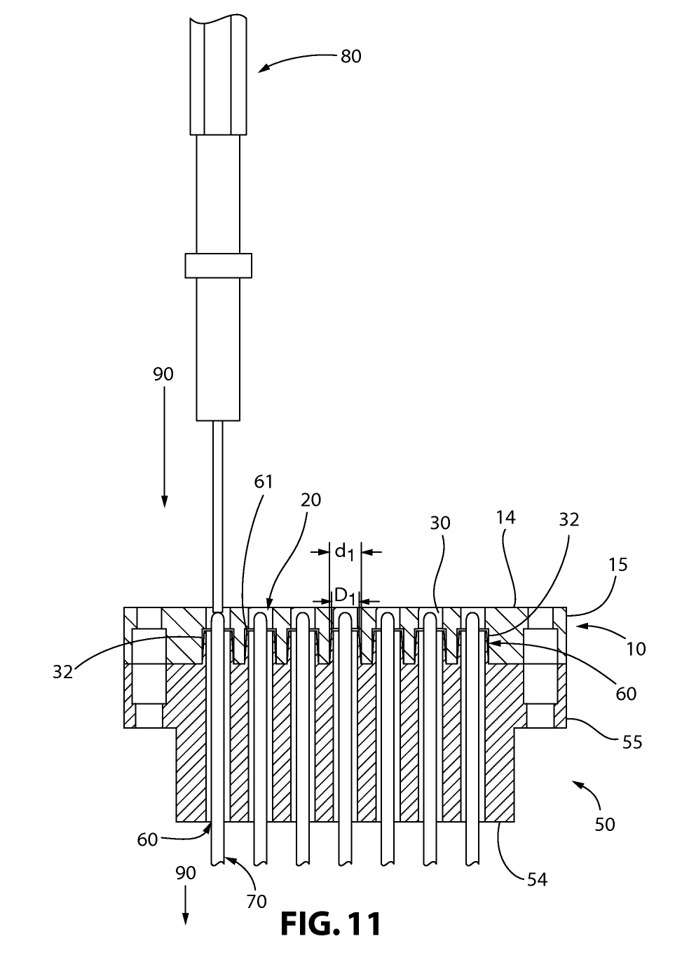

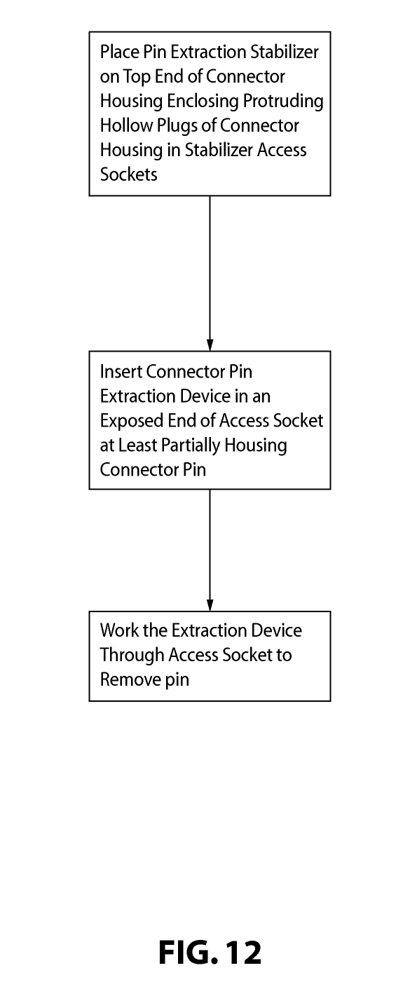

Referring to FIGS. 11-12, a method of extracting a connector pin predisposed in a connector housing will now be described. As described earlier, the connector housing includes a connector pin cavity spanning a top and a bottom end and a protruding hollow plug extending around the connector pin cavity at the top end. The connector pin is inserted from the bottom end of the connector housing and through at least the connector pin cavity and the protruding hollow plug to expose a connector pin contact beyond the protruding hollow plug. The method includes the step of placing a pin extraction stabilizer on the top end of the connector housing. The pin extraction stabilizer will include one or more access sockets that extend between a front and back surface of the stabilizer, such that at least one of the connector pin contact and the protruding hollow plug that surrounds it is housed within its corresponding access socket of the pin extraction stabilizer. The method further includes inserting a connector pin extraction device through the access socket via the back surface of the stabilizer. The choice of the access socket is made based on the connector pin that has to be extracted. Typically, each access socket houses only one connector pin. The method further includes the step of working the connector pin extraction device through the access socket to extract the connector pin. In another embodiment, the method further involves removing the connector pin by pushing the connector pin extraction device towards the connector housing, thereby extracting the connector pin without any damage to the connector housing.

In accordance with another embodiment of the present technique, and particularly referring to FIG. 11, a method of extracting an electronic pin 70 from connector housing 50 may include providing the pin extraction stabilizer 10 and positioning a front surface 12 of pin extraction stabilizer 10 toward or against the top end 52 of connector housing 50. The plugs 62 of connector housing 50 are received by a corresponding access sockets 20 defined within front surface 12 of pin extraction stabilizer 10, such that each connector plug 62 is encased with an access sockets 20. At this point, the pin 70 may be extracted through the back surface 14 of pin extraction stabilizer 10 via access sockets 20 without chance of breakage. The extraction tool 80 may be provided in order to facilitate the actual extraction of pin 70 from the connector housing 50. As shown, the tool 80 may be inserted into access sockets 20 of pin extraction stabilizer 10 at the back surface 14 of pin extraction stabilizer 10. Upon insertion through access sockets 20 and therefore into chamber 30 of pin extraction stabilizer 10, the pin extraction tool 80 engages and/or grasps the pin 70 positioned in the plug 62. The pin may then be removed from back surface 14 through access sockets 20. These steps may then be repeated in order to replace any other damaged pins that need to be extracted from connector housing 50.

If pin extraction stabilizer 10 were not provided, the space between adjacent plugs 62 of connector housing 50 makes it likely that an operator, when inserting a tool 80 into plug 62 to remove a pin 70, may provide inadvertent lateral movement of tool 80 causing the plug 62 to break or crack; thereby requiring complete replacement of connector housing 50. The lack of space between the walls 32 of chambers 30 and plugs 62, as explained above, prevents any such breakage from occurring saving extensive time and money.

As noted above, while specific embodiments of the invention have been described, it will be appreciated by those skilled in the art that various modifications and alternatives to those details could be developed in light of the overall teachings of the disclosure. The presently preferred embodiments described herein are meant to be illustrative only and are not limiting as to the scope of the invention which is to be given the full breadth of the appended claims and any and all equivalents thereof.

The invention claimed is:

1. A pin extraction stabilizer for aiding in efficient removal of a connector pin predisposed in a connector housing, the connector housing comprising:
one or more connector pin cavities spanning a top and a bottom end;
a protruding hollow plug extending around each of the one or more connector pin cavities at the top end,
wherein the connector pin is inserted from the bottom end of the connector housing and through one of the one or more connector pin cavities and the corresponding protruding hollow plug to expose a connector pin contact beyond the protruding hollow plug, the pin extraction stabilizer comprising:
a front surface;
a back surface opposing the front surface; and
a plurality of access sockets each extending between the front and the back surface of the pin extraction stabilizer;
wherein placement of each of the access sockets corresponds to placement of the protruding hollow plugs on the connector housing; and
wherein each of the access sockets is adapted to engage the corresponding protruding hollow plug of a plurality of plugs of the connector housing when the pin extraction stabilizer is mated with the top end of the connector housing.

2. The pin extraction stabilizer of claim 1, wherein a number of access sockets in the pin extraction stabilizer equals a number of protruding hollow plugs in the connector housing.

3. The pin extraction stabilizer of claim 1, wherein the plurality of access sockets comprises 28 access sockets.

4. The pin extraction stabilizer of claim 1, wherein each of the access sockets defines a first inner cross-section diameter and a second inner cross-section diameter.

5. The pin extraction stabilizer of claim 4, wherein the first inner cross-section diameter is different from the second inner cross-section diameter.

6. The pin extraction stabilizer of claim 5, wherein each of the access sockets defines a counterbored chamber.

7. The pin extraction stabilizer of claim 4, wherein the first and/or the second inner cross-section diameter of one of the sockets is different from the first and/or second inner cross-section diameter of another socket of the plurality of sockets.

8. The pin extraction stabilizer of claim 1, wherein each access socket is further adapted to allow an extraction tool to be inserted into the access socket to push out an existing connector pin from the connector housing.

9. The pin extraction stabilizer of claim 1, wherein the front surface of the pin extraction stabilizer contacts the top end of the connector housing during operation.

10. The pin extraction stabilizer of claim 1, wherein each plug fits within a corresponding access socket of the pin extraction stabilizer when in operation.

11. The pin extraction stabilizer of claim 1, wherein at least one of the front surface, the back surface, and the access sockets of the extractions stabilizer comprises a plastic material.

12. The pin extraction stabilizer of claim 1, wherein at least one of the front surface, the back surface, and the access sockets of the extraction stabilizer comprises a phenolic or diallyl phthalate material.

13. The pin extraction stabilizer of claim 1, wherein at least one of the front surface, the back surface and the access sockets of the extraction stabilizer comprises a metal.

14. The pin extraction stabilizer of claim 13, wherein the metal is selected from the group consisting of aluminum, steel, titanium, magnesium and derivatives thereof.

15. The pin extraction stabilizer of claim 13, wherein the access sockets comprise an insulating liner around the periphery of the access sockets.

16. The pin extraction stabilizer of claim 1, wherein at least one of the front surface, the back surface, and the access sockets of the extraction stabilizer comprises a ceramic material.

17. A method of extracting a connector pin predisposed in a connector housing, the connector housing comprising a connector pin cavity spanning a top and a bottom end and a protruding hollow plug extending around the connector pin cavity at the top end, and wherein the connector pin is inserted from the bottom end of the connector housing and through at least the connector pin cavity and the protruding hollow plug to expose a connector pin contact beyond the protruding hollow plug, the method comprising:
placing a pin extraction stabilizer on the top end of the connector housing, the pin extraction stabilizer comprising at least an access socket extending between a front and a back surface wherein at least one of the connector pin contacts and the protruding hollow plugs are housed within the corresponding access socket of the pin extraction stabilizer;
positioning a connector pin extraction device in an exposed end of the access socket, wherein the access cavity at least partially houses the connector pin to be extracted; and
removing the connector pin from the connector housing by working the connector pin extraction device.

18. The method of claim 17, wherein the step of removing the connector pin comprises pushing the connector pin extraction device towards the connector housing, extracting the connector pin without any damage to the connector housing.
